(19) United States
(12) Patent Application Publication
(10) Pub. No.: US 2023/0014497 A1
(43) Pub. Date: Jan. 19, 2023

(54) CARD CLUTCH

(71) Applicant: Deborah J. Baylor, Ft. Worth, TX (US)

(72) Inventor: Deborah J. Baylor, Ft. Worth, TX (US)

(21) Appl. No.: 17/378,764

(22) Filed: Jul. 18, 2021

(51) Int. Cl. G06K 19/077

(52) U.S. Cl. CPC G06K 19/077

(57) ABSTRACT

An illustrated view of a back of a credit/debit card coupled to a credit card claw for removing a bank card from a bank card reader is presented. The credit card claw is useful for providing a time efficient and a cost-effective device for helping to remove the credit/debit card from a bank card reader after being inserted.

### FIELD OF THE INVENTION

This invention relates to credit and debit cards. More particularly, it relates to a holder for removing a credit or debit card from a card reader.

### BACKGROUND

A credit card is a payment card issued to users (cardholders) to enable the cardholder to pay a merchant for goods and services based on the cardholder's promise to the card issuer to pay them for the amounts plus the other agreed charges. The card issuer (usually a bank) creates a revolving account and grants a line of credit to the cardholder, from which the cardholder can borrow money for payment to a merchant or as a cash advance.

A debit card (also known as a bank card, plastic card or check card) is a plastic payment card that can be used instead of cash when making purchases. It is similar to a credit card, but unlike a credit card, the money is immediately transferred directly from the cardholder's bank account when performing any transaction. In essence, the debit card is used as the credit card is used except for how the funds being utilized are obtained by the credit/debit card company.

Some debit cards might carry a stored value with which a payment is made (prepaid card), while most relay a message to the cardholder's bank to withdraw funds from a payer's designated bank account. In some cases, the primary account number is assigned exclusively for use on the Internet and there is no physical card. This is referred to as a virtual card.

A credit card is different from a charge card, which requires the balance to be repaid in full each month or at the end of each statement cycle. In contrast, credit cards allow the consumers to build a continuing balance of debt, subject to interest being charged. A credit card also differs from a cash card, which can be used like currency by the owner of the card. A credit card differs from a charge card also in that a credit card typically involves a third-party entity that pays the seller and is reimbursed by the buyer, whereas a charge card simply defers payment by the buyer until a later date. In 2018, there were 1.122 billion credit cards in circulation in the U.S.

A credit card issuing company, such as a bank or credit union, enters into agreements with merchants for them to accept their credit cards. Merchants often advertise in signage or other company material which cards they accept by displaying acceptance marks generally derived from logos. Alternatively, this may be communicated, for example, via a restaurant's menu or orally, or stating, “We don't take credit cards”.

Visa, MasterCard, and American Express are card-issuing entities that set transaction terms for merchants, card-issuing banks, and acquiring banks.

The credit card issuer issues a credit card to a customer at the time or after an account has been approved by the credit provider, which need not be the same entity as the card issuer. The cardholders can then use it to make purchases at merchants accepting that card. When a purchase is made, the cardholder agrees to pay the card issuer. The cardholder indicates consent to pay by signing a receipt with a record of the card details and indicating the amount to be paid or by entering a personal identification number (PIN). Also, many merchants now accept verbal authorizations via telephone and electronic authorization using the Internet, known as a card-not-present transaction (CNP).

Electronic verification systems allow merchants to verify in a few seconds that a card is valid and the cardholder has sufficient credit to cover the purchase, allowing the verification to happen at time of purchase. The verification is performed using a credit card payment terminal or point-of-sale (POS) system with a communications link to the merchant's acquiring bank. Data from the card is obtained from a magnetic stripe or chip on the card or the computer chip in the card.

For card not present transactions where the card is not shown (e.g., e-commerce, mail order, and telephone sales), merchants additionally verify that the customer is in physical possession of the card and is the authorized user by asking for additional information such as the security code printed on the back of the card, date of expiry, and billing address.

Credit and debit cards are often used to access one's account via an automatic teller machine (ATM) or by a point of service unit (POS) when making a purchase. When the computer chip is utilized, the card is slid into a slot in the ATM or POS and is quickly pulled out. Sometimes there is an issue when the credit/debit card is coupled to the slot of the ATM or POS. To fix this, one must use their fingers to securely grasp an end of the credit/debit card and pull the card out. This can be difficult to do and can also damage fingernails or make fingers sore or cause damage to the card.

In light of the foregoing, it would be desirable for a device that provides a coupling to the credit/debit card and then can be coupled to a finger or other non-card object to retrieve the card without injury, damage to the person and damage to the credit card.

### BRIEF DESCRIPTION OF THE DRAWINGS

FIG. 1A is an illustrated view of an exemplary credit card claw.

FIG. 1B is an illustrated view of a back of a credit/debit card coupled to a credit card claw.

FIG. 1C is an illustrated view of a front of the credit/debit card coupled to a credit card claw shown in FIG. 1A.

FIG. 1D is an of the credit/debit card coupled to a credit card claw shown in FIG. 1B.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

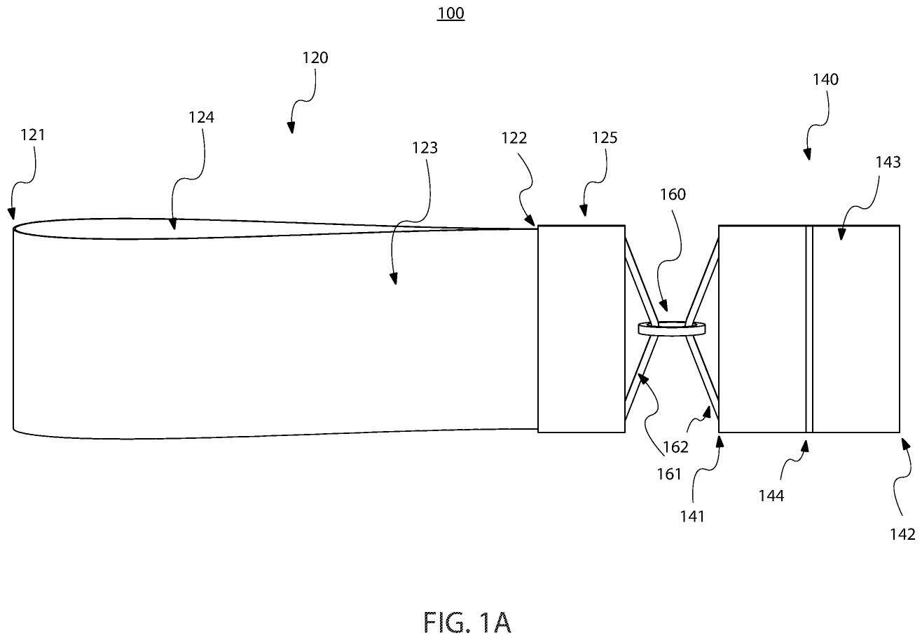

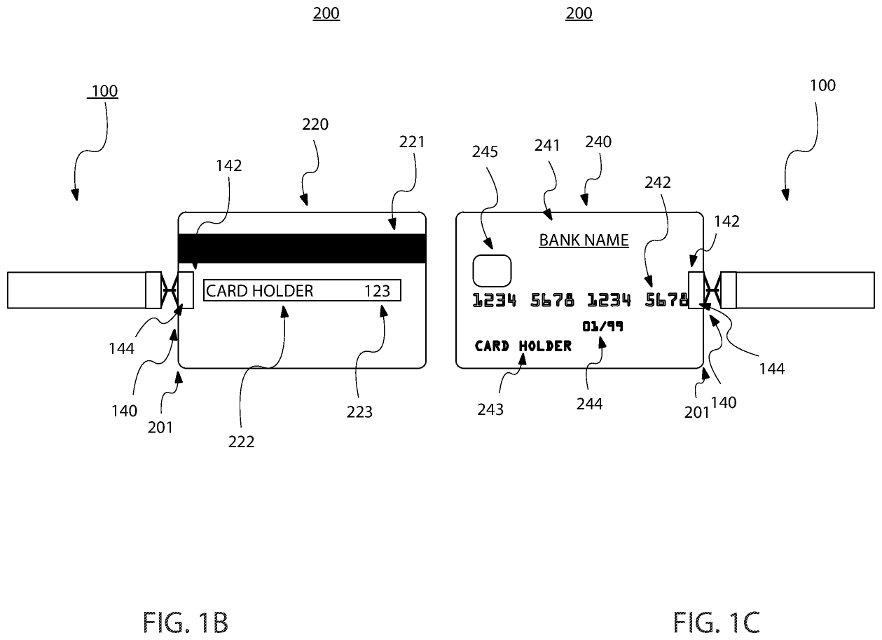

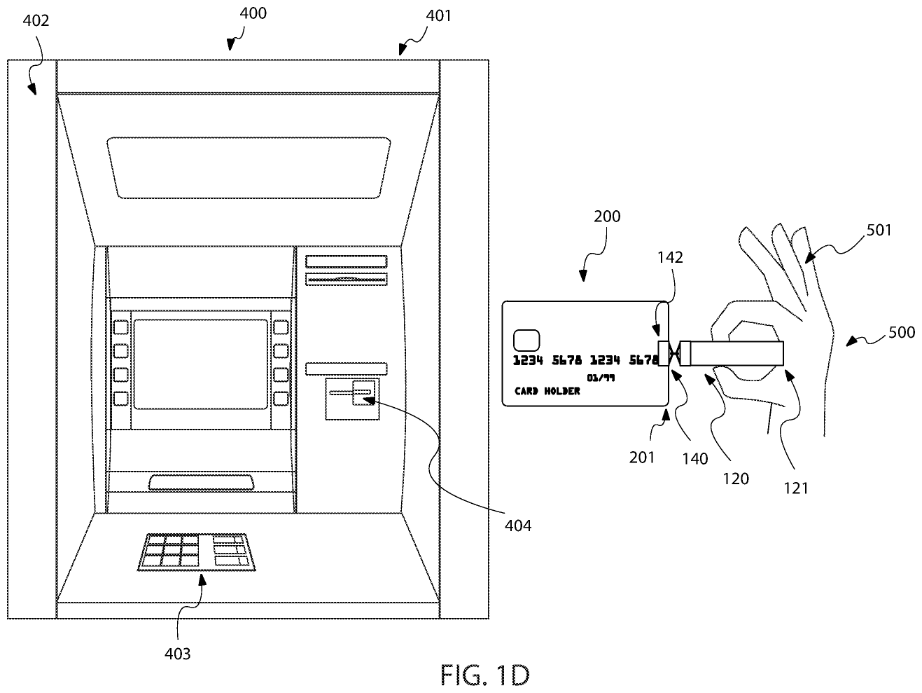

Referring to FIG. 1A., FIG. 1B and FIG. 1C, an illustrated view of a back of a credit/debit card 200 coupled to a credit card claw 100 for removing a bank card from a bank card reader is presented. The credit card claw 100 is useful for providing a time efficient and a cost effective device for helping to remove the credit/debit card 200 from a bank card reader after being inserted.

The credit card claw 100 has a first portion 120, a second portion 140 and a coupler 160 which has an elongated body. The credit card claw is preferably an elongated shape, however other shapes are hereby contemplated, including, but not limited to, square, oblong, rectangular, etc. The first portion 120 of the credit card claw 100 is preferably made of a leather material, however other materials are hereby contemplated, including, but not limited to, plastic, nylon, cotton, etc. The second portion 140 of the credit card claw 100 is preferably made of a leather material, however other materials are hereby contemplated, including, but not limited to, plastic, nylon, cotton, etc. The coupler 160 of the credit card claw 100 is preferably made of a plastic material, however other materials are hereby contemplated, including, but not limited to, metal, poly-vinyl chloride (PVC), etc.

The first portion 120 of the credit card claw 100 has a first end 121, a second end 122 and a middle portion 123. The first end 121 of the first portion 120 of the credit card claw 100 is preferably a loop, such that a middle 124 of the middle portion 123 is void and allows for a finger or object to hold the credit card claw 100.

The second end 122 of the first portion 120 of the credit card claw 100 is coupled to a first end 161 of the coupler 160 of the credit card claw 100. The second end 122 of the first portion 120 may be coupled to the first end 161 of the coupler 160 by attaching the second end 122 of the first portion 120 to the first end 161 of the coupler 160 or by using a first coupling device 125, such as a clamp, latch, hinge, etc.

The second portion 140 of the credit card claw 100 has a first end 141, a second end 142 and a middle portion 143. The second portion 140 of the credit card claw 100 is flat.

The first end 141 of the second portion 140 of the credit card claw 100 is coupled to a second end 162 of the coupler 160 of the credit card claw 100. The first end 141 of the second portion 140 may be coupled to the second end 162 of the coupler 160 by attaching the first end 141 of the second portion 140 to the second end 162 of the coupler 160 or by using the first coupling device 125, such as a clamp, latch, hinge, etc.

The second end 142 of the second portion 140 is removably coupled to a first edge 201 of the credit/debit card 200. The second end 142 of the second portion 140 is preferably a second coupling device 144, such as a hinge, clamp, clasp, etc. The second coupling device 144 of the second end 142 of the second portion 140 of the credit card claw 100 is securely and removably coupled to the first edge 201 of the credit/debit card. This allows for a quick and time efficient removal of the credit/debit card 200 from a card reading device (shown in FIG. 1C). The use of the credit card claw 100 coupled to the credit/debit card 200 is described in FIG. 1C.

FIG. 1B, an illustrated view of the back 220 of the credit/debit card 200 is shown coupled to the credit card claw 100 shown in FIG. 1A is presented.

The back 220 of the credit/debit card 200 has a magnetic strip 221, a signature area 222 and a pin 223. As described earlier, the second end 142 of the second portion 140 of the credit card claw 100 is coupled to the first edge 201 of the credit/debit card 200. In particular, the second coupling device 144 of the second end 142 of the second portion 140 of the credit card claw 100 is securely and removably coupled to the first edge 201 of the credit/debit card 200.

FIG. 1C, an illustrated view of the front 240 of the credit/debit card 200 is shown coupled to the credit card claw 100 shown in FIG. 1A is presented.

The front 240 of the credit/debit card 200 has a banking institute 241, an account number 242, a card holder name 243, a good-thru date 244 and a computer chip 245. As described earlier, the second end 142 of the second portion 140 is coupled to the first edge 201 of the credit/debit card 200. In particular, the second coupling device 144 of the second end 142 of the second portion 140 of the credit card claw 100 is securely and removably coupled to the first edge 201 of the credit/debit card 200.

Moving now to FIG. 1D, an illustrated use of the credit card claw 100 coupled to the credit/debit card 200 is presented.

A POS 400 is shown where the POS 400 is an automated teller machine 401 although any other type of credit/debit card reader is hereby contemplated. The ATM 401 has a body 402, a keypad 403 and a card slot 404. The ATM 401 allows for the reading of the computer chip 245 (not shown in FIG. 1D). The second end 142 of the second portion 140 of the credit card claw 100 is coupled to the first edge 201 of the credit/debit card 200.

The credit/debit card 200 is inserted into the card slot 404 of the ATM 401. The keypad 403 of the ATM 401 is then accessed to give details of the type of transaction and any private information number (PIN) that is needed to verify a user of the credit/debit card 200. The first end 121 of the first portion 120 of the credit card claw 100 is coupled to one or more fingers 501 of a hand 500.

Once the credit/debit card 200 is inserted into the card slot 404 of the ATM 401 and the transaction has completed, the hand 500 is moved away from the ATM 401 and the credit/debit card 200 is removed from the card slot 404 of the ATM 401.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A credit card claw device for retrieving a credit/debit card from a point of sale (POS) card reader, the device consisting of:
a coupler, the coupler having a first end and a second end; a first portion, the first portion comprising:
a first end;
a second end, the second end being coupled to the first end of the coupler by a first coupling device; and
a middle, the middle having a middle portion, wherein the middle portion for receiving a finger of a person;
a second portion, the second portion comprising:
a first end, the first end of the second portion being coupled to the coupler; and
a second end, the second end of the second portion being coupled to a second coupling device, wherein the second coupling device being a clasp, wherein the second coupling device securely and removably coupling the credit card claw to a first edge of the credit/debit card.

2. The device of claim 1, wherein the first portion being made of a leather material.

3. The device of claim 1, wherein the device being an elongated shape.

4. The device of claim 1, wherein second portion being made of a leather material.

5. The device of claim 1, wherein coupler being made of a plastic material.

6. The device of claim 1, wherein the first coupling device being a clamp.

7. (canceled)
